(19) United States
(12) Patent Application Publication
(10) Pub. No.: US 2026/0032083 A1
(43) Pub. Date: Jan. 29, 2026

(54) RECEIVER-SIDE SCALABLE CONGESTION CONTROL

(71) Applicant: Netduma Software LTD, London (GB)

(72) Inventor: Iain Kibet Fraser, Cambridge (GB)

(73) Assignee: Netduma Sofware LTD, London, EN (GB)

(21) Appl. No.: 19/283,113

(22) Filed: Jul. 28, 2025

Related U.S. Application Data
(60) Provisional application No. 63/676,874, filed on Jul. 29, 2024.

(51) Int. Cl. H04L 47/122

(52) U.S. Cl. CPC H04L 47/122

(57) ABSTRACT

A middlebox is inserted downstream from a bottleneck and a marking node is inserted upstream from the bottleneck. When a non-TCP message is received at the middlebox, the middlebox sends a message to the marking node to mark messages being downloaded as enabled for a particular protocol and marked to reflect an expedited forwarding (e.g., DCSP 45). When a node having the bottleneck receives the message having the ECT(1) marking, if there is congestion, the ECT(1) marking is changed to Congestion Experienced (CE). The middlebox reacts to the marking by controlling the sender to follow a scalable congestion controller response curve achieved by (1) NonTCP QB flows are controlled by delaying acknowledgments and selectively dropping messages and (2) TCP flows are controlled by overwriting the receive window in acknowledgments. Alternatively, TCP flows where the server supports L4S can be controlled by echoing congestion via ‘Accurate ECN’.

### CROSS REFERENCE TO RELATED APPLICATIONS

This specification claims priority benefit of U.S. Provisional Patent Application Ser. No. 63/676,874 (Docket #CA-11), entitled “RECEIVER-SIDE SCALABLE CONGESTION CONTROL,” filed Jul. 29, 2004, by Iain Kibet Fraser, which is incorporated herein by reference.

### FIELD

The current specification relates to reducing congestion in network communications, benefiting latency-sensitive applications, such as communications related to online games.

### BACKGROUND

The subject matter discussed in the background section should not be assumed to be prior art merely because it is mentioned in the background section. Similarly, a problem mentioned in the background section or associated with the subject matter of the background section should not be assumed to have been previously recognized in the prior art. The subject matter in the background section merely represents different approaches, which in and of themselves may also be inventions.

Some applications, such as Voice Over Internet Protocol (VoIP) and online gaming, do not tolerate communication latency well. For example, in an online video game, a player may attempt to engage a hostile entity only to discover that the player's avatar was attacked and eliminated before having a chance to respond. Continuing the example, just as the player selects a button to make a move (for example), the screen freezes, and then after the screen unfreezes, the player's avatar is lying on the ground, depleted of life points.

Protocols, such as Transmission Control Protocol (TCP), probe for available bandwidth (RFC 793 is incorporated herein by reference). When no congestion is detected, the protocol increases the sender's sending rate. When congestion is detected, the sending rate is reduced. Generally, the protocol behavior results in throughput that follows a saw-tooth-like pattern.

Congestion-controlling protocols can negatively impact latency-sensitive applications (LSA), such as gaming and VoIP, because bandwidth probing eventually causes the sending rate to exceed the link rate, resulting in growing packet queues that incur latency.

Unfortunately, due to the decay and growth dynamics of traditional controllers, the recovery time increases as the pipe length and/or width increases (the “pipe” refers to the product of the bandwidth and delay, where the length of the pipe represents the propagation delay from client to server, and the width represents the bandwidth from server to client. If the bandwidth and/or the delay from server-to-client increases, then the number of in-flight packets required to keep the link busy increases). With traditional protocols, maintaining high-traffic link utilization requires a sawtooth pattern with high amplitudes. As a consequence, traditional protocols either have high queue variability or link underutilization.

Scalable sender-side (e.g., server-side) congestion controllers have recovery times that scale with the length of the pipe. Scalable sender-side congestion controllers can achieve high link utilization with very shallow queues by reducing the amplitude of the controller's saw tooth pattern.

An example of a scalable sender-side controllable Low Latency, Low Loss, and Scalable Throughput (L4S) which uses accurate Explicit Congestion Notification (ECN) to achieve high throughput without the sawtooth pattern (RFC 9330 and RFC 3168 are incorporated herein by reference).

In this specification, “before” means “upstream from” and “after” means “downstream from.” When uploading messages, downstream is the end closer to the server. When downloading, “downstream” refers to the end closer to the receiver (e.g., a client). Also, the words “flow,” “message,” “packet,” and “stream” are used interchangeably. Any of these words may be substituted for the other throughout the specification to obtain different embodiments.

### BRIEF DESCRIPTION

In the following drawings like reference numbers are used to refer to like elements. Although the following figures depict various examples of the invention, the invention is not limited to the examples depicted in the figures.

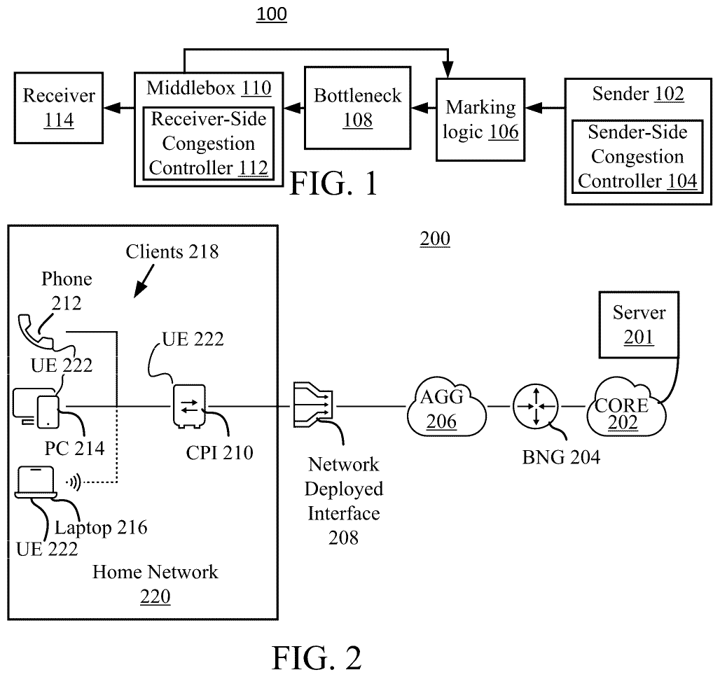

FIG. 1 illustrates an example of a system in which the invention can be implemented.

FIG. 2 illustrates an example of some hardware that may be included in parts of the system of FIG. 1.

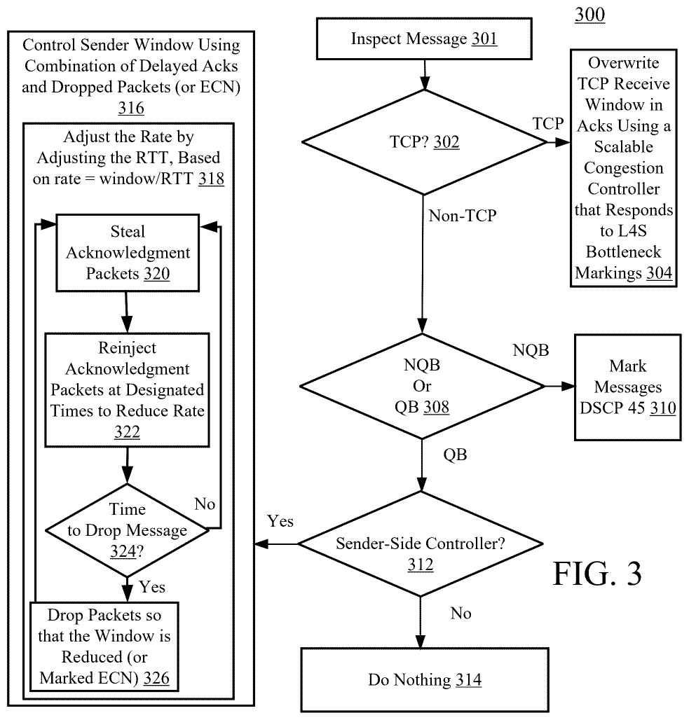

FIG. 3 illustrates a flowchart of an example of a method that is implemented in the system of FIG. 1, which is driven by a receiver-side congestion controller (e.g., a client-side congestion controller.

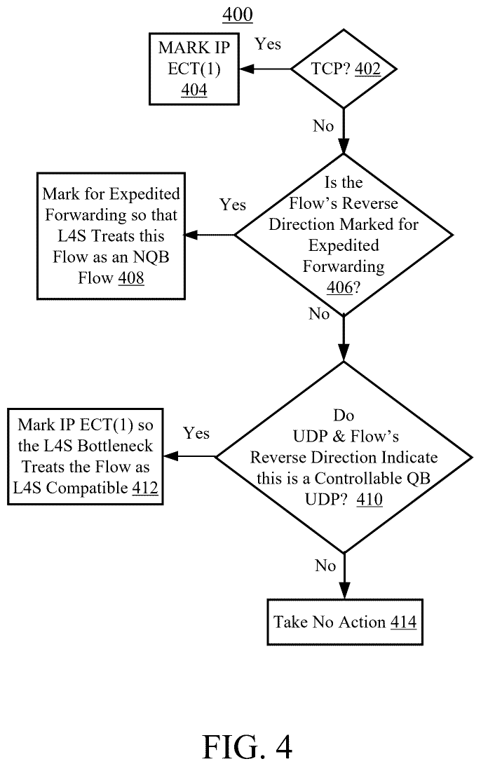

FIG. 4 illustrates another flowchart of another example of a method implemented on the system of FIG. 1, which is implemented by the marking module.

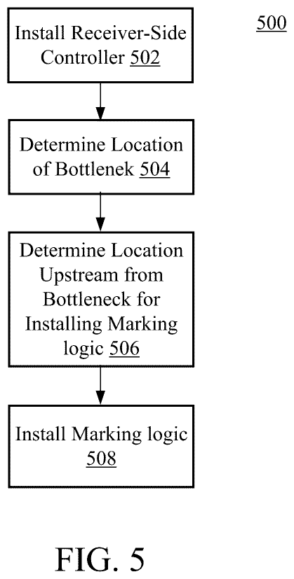

FIG. 5 illustrates a flowchart of an embodiment of a method of setting up the system of FIG. 1.

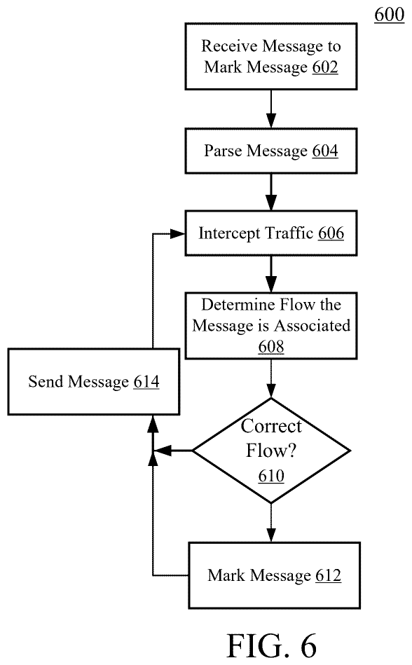

FIG. 6 illustrates a flowchart of an embodiment of a method implemented by the marking logic.

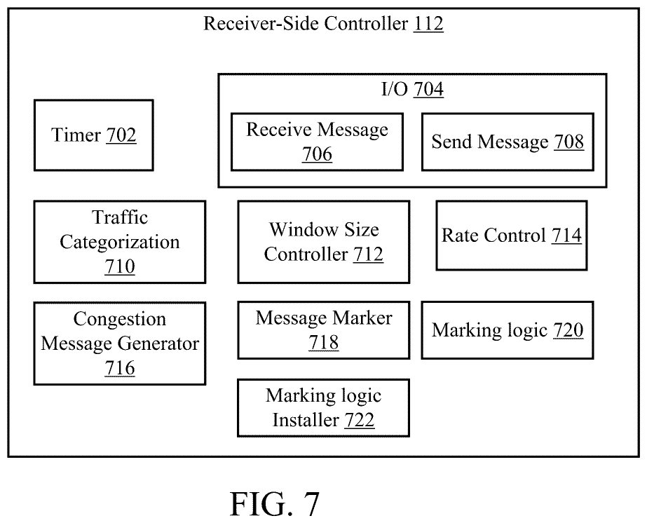

FIG. 7 is a block diagram of an embodiment of the receiver-side congestion controller.

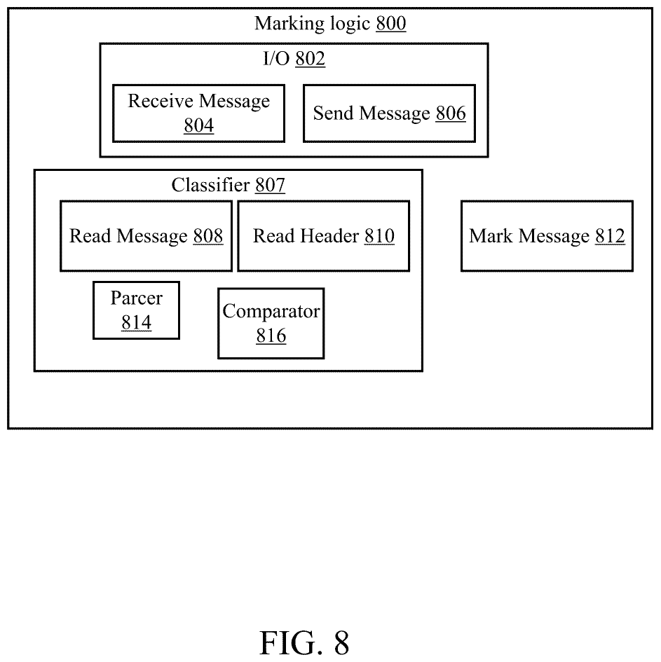

FIG. 8 illustrates a block diagram of marking logic.

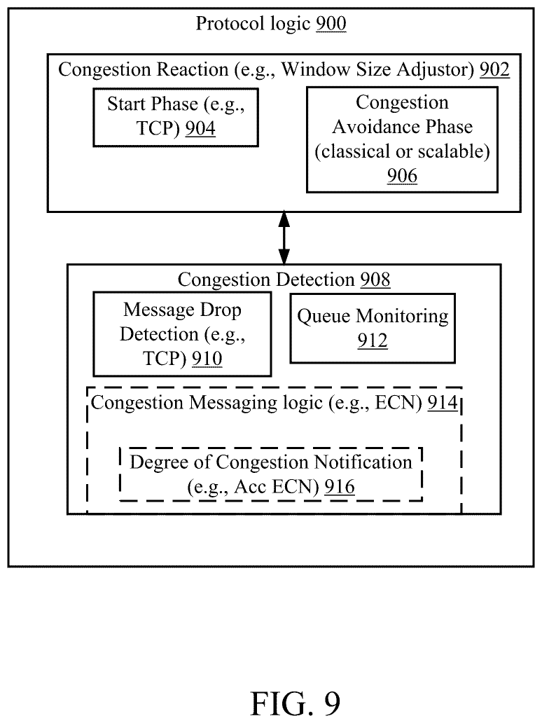

FIG. 9 illustrates a block diagram of an example of a sender-side congestion controller.

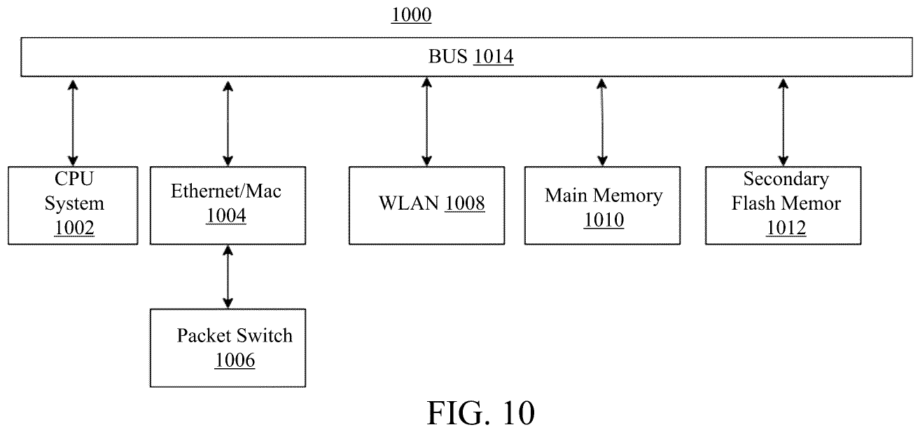

FIG. 10 illustrates an example of a router that can be used in the system of FIG. 1.

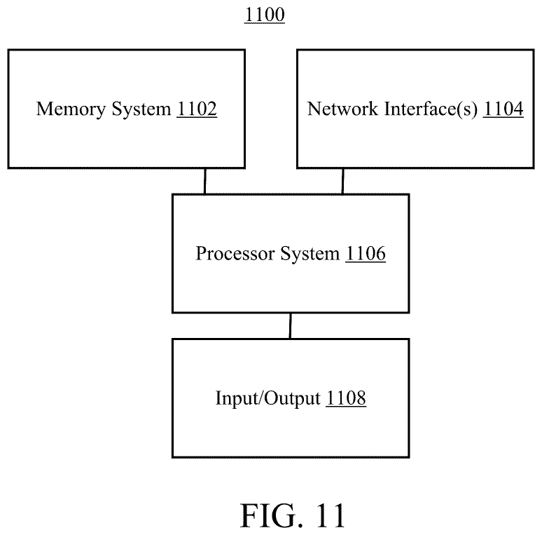

FIG. 11 illustrates an example of a network machine that may be used as the sender, receiver, or other device of FIG. 1 or 2.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Although in this specification, the example of a player playing an online game is often used, other types of users may be substituted for the players, and other services may be substituted for a game to obtain different embodiments.

In this specification, the term “message” is generic to a packet, frame, or other message unit. Throughout this specification, a “packet,” a “frame,” or “another message unit” can be substituted for a “message” to obtain another embodiment. In this specification, the term “logic” is generic to hardware (e.g., a logic circuit), firmware, software (e.g., machine instructions), and combinations of the three. U.S. Pat. No. 6,785,872, which is entitled “Algorithm-to-hardware system and method for creating a digital circuit,” discloses a system that converts an algorithm to a circuit. U.S. Pat. No. 6,785,872 is hereby incorporated into the specification by reference.

The receiver-side congestion controller is placed downstream from a bottleneck, which manipulates a sender-side congestion controller. The sender-side congestion controller is located upstream from the bottleneck. The receiver-side congestion controller communicates with a node having marking logic to ensure that downstream traffic is marked for expedited forwarding. The receiver-side congestion controller adds ECN information to upstream traffic so that the traffic will be treated as L4S compliant, and the sender-side congestion controller will process the message according to the L4S protocol.

In some embodiments, the sender-side congestion controller includes logic that handles (e.g., manages, controls, and/or reduces) congestion. In some embodiments, the sender-side congestion controller includes congestion detection logic. In some embodiments, the congestion detection logic includes message drop detection logic that detects dropped messages by determining whether an acknowledgment of a message was received within a given window of pipe size, via the detection of duplicate acknowledgments (acks) or an alternative signaling mechanism, such as TCP selective acknowledgements (SACKs) (RFC 2018 is incorporated herein by reference). The sender-side congestion controller includes logic that modulates the sending rate by adjusting the window (e.g., in some embodiments, the sender-side congestion controller includes TCP logic). In some embodiments, the sender-side congestion controller includes logic for detecting message drops and adjusting the window size during which acknowledgements of messages sent are accepted. If no acknowledgement of a message is received during the window, the message is treated as having been dropped. When the sender-side congestion controller detects that a message has been dropped, the logic assumes that there is congestion in the flow, and corrective action is taken by the logic, such as by decreasing the window (e.g., by window size adjustor logic). In some embodiments, the congestion detection logic includes logic for detecting congestion in other ways. For example, in some embodiments, the sender-side congestion controller includes logic that detects the length of queues and sends messages to adjust the size of the window based on how full the queue is (as opposed to relying only on the dropping of messages as an indication of congestion) so that messages do not need to be dropped as often, to avoid congestion. In some embodiments, the sender-side congestion controller includes Explicit Congestion Notification (ECN) detection logic that interprets markings in messages to indicate the presence of congestion, thereby communicating the presence of congestion by the marking messages, without relying on the detection of a dropped message to determine the presence of congestion. In some embodiments, the sender-side congestion controller includes logic that detects an extent or a degree of congestion, rather than just the presence of congestion (e.g., in some embodiments, the sender-side congestion controller includes an Accurate ECN (Acc ECN) logic) (RFC 7560 is incorporated herein by reference). In some embodiments, the sender-side congestion controller includes logic for a growth phase, in which the logic probes until an appropriate size for the window is found. The sender-side congestion controller includes logic for a congestion avoidance phase during which the sender-side congestion controller monitors the flow and adjusts the window to avoid congestion. In some embodiments, the sender-side congestion controller includes scalable congestion control logic that adjusts the window, such that the recovery time does not scale with the size of the pipe (e.g., the sender-side congestion controller includes a TCP Prague congestion controller).

To enforce high-fidelity congestion control (e.g., scalably), the congestion receiver-side congestion controller is placed downstream from the bottleneck (e.g., on a middlebox or “congestion middlebox”), and a marking node is placed upstream from, or at, the bottleneck. The marking node marks the flows at or upstream from the bottleneck, and the congestion logic can be deployed on a middlebox or the client.

Regarding high-fidelity/scalable congestion control, in classical TCP Reno, during the steady-state behavior, the window is increased by 1 message unit every Round Trip Time (RTT) and halved when a congestion signal is received. Consequently, the window, w, is given by,

$$w = {( 8 / 3 p )}^{1 / 2} , \qquad ( Eq . 1 a )$$

where “p” is the probability of a congestion event. Also, the number of consecutive packets before a congestion event, x (which is the recovery time, the time needed to recover from a congestion event), is given by,

$$x = 1 / p . \qquad ( Eq . 1 b )$$

The sender-side congestion controller sets a window that can be described by

$$w ∝ 1 / ( {p}^{B} ) . \qquad ( Eq . 2 )$$

For example, in the case of classical TCP Reno, B=½. When B≥1, the sender-side congestion controller is classified as scalable.

Eq. 2 describes the steady-state behavior. For a classical controller, the change in amplitude for the periodic pattern caused by the congestion response and recovery (e.g., sawtooth) is large, resulting in a low-fidelity congestion response. The reasons are as follows.

Since x=1/p when x is substituted in Eq. 2, one obtains,

$$w ∝ {x}^{B} . \qquad ( Eq . , 3 a )$$

Eq. 3a can be transposed to make x the subject:

$$x ∝ {w}^{( 1 / B )} . \qquad ( Eq . , 3 b )$$

If the exponent is less than or equal to 1, then as the window grows, the recovery time x does not grow. Thus, if B≥1, then the controller is scalable with the “pipe size,” the size of the window, and is classified as a scalable congestion controller.

### THE SYSTEM

FIG. 1 illustrates a system 100 according to some embodiments of the invention. In some embodiments, system 100 includes sender 102, sender-side congestion controller 104, marking logic 106, bottleneck 108, middlebox 110, receiver-side congestion controller 112, and receiver 114. System 100 is an example of a network. In FIG. 1, sender 102 sends a message to receiver 114. In some embodiments, sender-side congestion controller 104 is a TCP and/or L4S congestion controller, which controls congestion using TCP congestion control and/or L4S congestion control protocol.

In some embodiments, sender 102 and receiver 114 include logic for communicating with

one another as server and client, respectively. Sender-side congestion controller 104 controls the rate at which to send traffic. Sender-side congestion controller 104 attempts to control congestion from the sender side. Between the sender 102 and the receiver 114 is a bottleneck 108. To address the bottleneck 108, a middlebox 110 is installed after (i.e., downstream from) the bottleneck 108, but “before” (i.e., upstream from) or on the receiver 114. Similarly, marking logic 106 is installed at a node before/upstream from, or on the bottleneck 108. For example, the marking logic 106 could, in rare instances, be installed at sender 102. The middlebox 110 includes logic that controls QB traffic by responding to bottleneck congestion and sending messages to the marking logic 106 to mark messages. In some embodiments, the middlebox 110 includes logic that controls congestion by writing/overwriting acknowledgment windows, delaying acknowledgments of messages, and/or dropping messages. In some embodiments, middlebox 110 includes a receiver-side congestion controller 112. Receiver-side congestion controller 112 includes logic for controlling congestion that is installed at the receiver side. Receiver-side congestion controller 112 manipulates the behavior of sender-sider congestion controller 104 (and middlebox 110), so that sender102 behaves as an L4S-compliant device and causes traffic sent to receiver 114 with low latency, low loss, and scalable throughput, even though the receiver is not necessarily L4S-compliant. In some embodiments, receiver-side congestion controller 112 is also capable of manipulating traffic and/or providing information, so that sender-side congestion controller 104 sends messages at a desired rate that minimizes congestion.

For Non-Queue Building (NQB) traffic, middlebox 110 marks upstream traffic for a higher priority, and in some embodiments, middlebox 110 indicates to the marking logic 106 to reflect that the marking in uploaded messages, so that the expedited forwarding is applied, while downloading messages (QB traffic is traffic that tends to build queues, and NQB traffic is traffic that is usually sensitive to queues and does not build queues). Specifically, assigning the expedited forwarding to messages being uploaded may cause the sender-side congestion controller 104 to assign expedited forwarding to messages being downloaded. When sending messages to receiver 114, marking logic 106 ensures that the messages that were not marked by the sender 102 for expedited forwarding are still marked for expedited forwarding.

In some embodiments, sender 102 receives some messages from receiver 114, and receiver 114 sends some messages to sender 102. However, more data is sent from sender 102 to receiver 114 than is sent from receiver 114 to sender 102. For example, receiver 114 sends an acknowledgement to sender 102. As another example, sender 102 sends multimedia and/or streaming game data viewed by players of a game, and receiver 114 sends keyboard input and cursor movement data, action information, a channel selection, a game selection, and/or game controller information to sender 102. As another example, the sender 102 sends audio information, and the receiver 114 sends information related to requesting a particular audio file, audio quality level, fidelity, and sampling rate. In some embodiments, sender 102 is a server, and receiver 114 is a client.

### RESIDENTIAL BROADBAND TOPOLOGY

FIG. 2 illustrates an example of residential broadband topology 200, which can be included in the system of FIG. 1. In some embodiments, residential broadband topology 200 includes server 201, core 202, Broad Band Network Gateway (BNG) 204, Aggregation (AGG) 206, Network Deployed Interface (NDI) 208, Client Premises Interface (CPI) 210, phone 212, Personal Computer (PC) 214, laptop 216, clients 218, home network 220, and UEs 222.

Server 201 provides a service to a client at a home network or an edge network. In this specification, the terms “sender” and “server” are used interchangeably and can be substituted one-for-another to obtain different embodiments. Core 202 in FIG. 2 represents the core network and may be located between the sender 102 and marking logic 106 in FIG. 1. BNG 204 is a component in an Internet Service Provider's (ISP) network, serving as the access point for subscribers to connect to broadband services. In some embodiments, BNG 204 manages subscriber sessions, aggregates traffic, and routes aggregate traffic to the Internet Service Provider's (ISP's) backbone network, ensuring quality of service and efficient data transmission. The AGG 206 refers to aggregated traffic flow between multiple customer sessions in the access network. For example, in some embodiments, AGG 206 includes an aggregation router, which collects and routes traffic from multiple lower-level networks to a higher-level network. In some embodiments, AGG 206 is deployed at the edge of a network, and AGG 206 provides a connection between a home network and the service provider network.

The NDI 208 is a network device that can be located in a system 100 (e.g., a telephone exchange or other network) that connects multiple Customer Premises Interfaces (CPIs) to a broadband and/or high-speed digital communications channel. NDI 208 can be a multi-subscriber modulation device. For example, NDI 208 can be a Digital Subscriber Line Access Multiplexer (DSLAM) or Cable Modem Termination System (CMTS). Note that the DSLAM is an xDSL (Digital Subscriber Line, the “x” is generic to the various types of DSLs). The type of DSL is based on the customer access type. The marking logic 106 is typically deployed on a device in the access network, such as BNG 204 or NDI 208 (or a DSLAM or CMTS, or other device upstream from the bottleneck 108).

CPI 210 can be any equipment located at the customer premises that interfaces with the system 100. As another example, CPI 210 can be a CMTS or Data Over Cable Service Interface Specification (DOCSIS) modem. Each residential broadband type or access has an equivalent multi-customer modulation device, either of which can be substituted accordingly in FIG. 2. The CMTS permits the addition of high-bandwidth data transfer to an existing Cable Television (CATV) system. For example, cable would have CMTS, typically, located in a cable company's headend or hub site, which is used to provide data services. CMTS can provide data services, such as cable Internet or VoIP, to cable subscribers. A CMTS provides many of the same functions provided by DSLAM in a DSL system. In this specification, the DSLAM refers to multi-subscriber modulation devices and can be substituted by the equivalent device for different access types, e.g., CMTS for cable/DOCSIS network communications, Optical Line Termination (OLT) for Passive Optical Networks (PON), gNodeB base station for LTE, 4G, 5G networks, etc. Since the upstream bottleneck is often on the CPI 210, it is relatively easy to update the device to include QoS to optimize the Quality of Experience (QoE) for the home users. For example, the queue on the CPI 210 for messages traveling towards the NDI 208 is likely to become congested, since the LAN clients 212, 214, 216 can send messages at a faster rate than CPI 210 uplink can handle (e.g., transmission on the link between CPI 210 and NDI 208).

In FIG. 2, downstream means downstream from the core 202 to CPI 210 (e.g., the home gateway (HG)/CPE). Upstream is the reverse, from home devices through the HG and onwards towards the core. In either direction, there is a single bottleneck, which is the lowest bandwidth forwarding device. The bottleneck 108 is where the queue forms, and thus where QoS (including L4S queue) should be deployed. The downstream bottleneck (bottleneck 108) (including the L4S bottleneck) is a device often between the BNG 204 and the NDI 208 (or DSLAM (inclusive)).

The upstream bottleneck is most likely on the CPI 210, if not a device shortly afterwards, and before the DSLAM (or CMTS, OLT, etc., depending on the WAN access type).

However, in the downstream direction, the same approach would require upgrading some devices between BNG 204 and/or NDI 208 (or equivalent). In the case of L4S, the clients (212, 214, 216, or 222) and server 201 would need to be upgraded to support L4S. Consequently, it is easier to install and deploy a receiver-side congestion controller 112 to address the downstream problem. Since the upstream bottleneck is often on the CPI 210, it is relatively easy to update the device to include QoS to optimize the Quality of Experience (QoE) for the home users. However, in the downstream direction, the same approach would require upgrading devices between BNG 204 and/or NDI 208 (or equivalent). Consequently, it is easier to install receiver-side congestion controller 112 to address the downstream problem. Both when uploading and downloading messages, the bottleneck 108 occurs at the lowest bandwidth forwarding device. At the bottleneck 108, a queue forms, and thus, a Quality of Service (QoS) queue (such as an L4S queue) should be deployed at the bottleneck 108. The downstream bottleneck occurs on a device (e.g., a router) between the BNG 204 and the NDI 208 (inclusive). In some embodiments, the upstream bottleneck is on the CPI 210.

The receiver-side congestion controller 112 can run on the CPI 210, which, in some embodiments, is an embedded Linux device with Wi-FI radios, and switches, and may include some form of network message forwarding hardware acceleration (“Wi-Fi” is a family of wireless protocols based on the IEEE 802.11 family of standards-Wireless Local Area Networks (WLAN), which are commonly used for local area networking of devices and Internet access, allowing nearby digital devices to exchange data by radio waves. The Wi-Fi devices and systems are interoperable. Alternatively, the receiver-side congestion controller 112 (e.g., located at the middlebox 110) can run at a remote location that can intercept communications between the CPI 210 and the server 201. In some embodiments, the receiver-side congestion controller 112 is installed on a Linux device or a general-purpose Operating System (OS). If the receiver-side congestion controller 112 is included on the CPI 210, in some embodiments, the receiver-side congestion controller 112 can be installed or upgraded by upgrading the OS or other CPI (e.g., CPE) software/firmware, which can be upgraded easily and cheaply. In contrast, updating the aggregate devices, such as the BNG 204, is often more difficult and costly. Also, adding advanced features to the devices that make up AGG 206 of FIG. 2 can be intractable.

The phone 212, Personal Computer (PC) 214, and laptop 216 are examples of clients 218. Clients 218 and CPI 210 (which may be a CPE or a Home Gateway (HG), for example), which are also examples of User Equipment (UE) 222. UE 222 may be part of the home network 220 and is part of the system 100 of FIG. 1. Although in FIG. 2, the CPI 210 and middlebox 110 are separate devices, middlebox 110 can be located at the CPI 210. The marking logic 106 and bottleneck 108, in FIG. 2, are located between the BNG 204 and the CPI 210 (inclusive).

In FIG. 2, server 201 is to the right of the core 202, client 218 is one of the devices in the home network 220 (at the far left), and the L4S queue is on bottleneck 108 in the downstream direction. In this specification, the terms “receiver,” “customer premises,” UE, and “client” are used interchangeably and can be substituted one-for-another to obtain different embodiments. Similarly, in this specification, the terms “sender” and “server” are used interchangeably and can be substituted one-for-another to obtain different embodiments. Congestion issues are generally more significant for traffic/flows in which the server 201 is the sender 102, and the client/CPI/CPE/UE is the receiver 114. Thus, typically, it is only necessary to address the congestion issues for the traffic traveling from the server 201 to the client/CPI/CPE/UE. Nonetheless, the methods/systems of this specification can be applied equally well when the client/CPI/CPE/UE is the sender 102 and the server 201 is the receiver 114.

### THE DOWNSTREAM BOTTLENECK

The downstream bottleneck is somewhere in the “access network.” In a typical broadband environment, in the downstream direction, the markings on the messages and the messages/acknowledgments (for controlling the flows) are applied by the marking logic 106 before or at the bottleneck 108. For example, the location of the marking logic 106 could be at the LAC (Layer 2 (L2) access concatenator), L2TP Network Server (LNS), BNG, or Broadband Remote Access Server (BRAS) router, which aggregates users from a portion of a region.

### FURTHER DISCUSSION OF FIGS. 1 AND 2

The downstream bottleneck is somewhere in the ‘access network’. In a typical broadband environment. For the L4S queue building protocols (such as TCP) to be deployed, the server 201, client 218, and bottleneck 108 all need to be updated. In this specification, a device such as the BNG 204 that is before or is the downstream bottleneck would mark the TCP packets with ECT (1). In some embodiments, marking logic 106 includes Cisco packet marking capabilities, which induce an L4S queue to behave as though the sender (server 201, which in this case) is L4S compatible.

In an L4S scenario, the sender 102 marks the message as ECT (1) (indicating that the sender is compatible with the L4S controller), and the bottleneck 108 marks the packets if there is congestion. The receiver 114 echoes the received packets in an ‘accurate ECN’ manner (e.g., by sending acknowledgments with Acc ECN congestion information). L4S controllers require compatible senders and receivers. In some embodiments, only the bottleneck 108 and CPI 210 need to be updated to achieve L4S performance.

### NON-QUEUE-BUILDING PROTOCOLS AND QUEUE-BUILDING TCP

As a result of the disclosed structures and methods, receiver 114 and receiver-side congestion controller 112 do not require any L4S information to function. As a result of the methods and apparatus disclosed herein, receiver-side congestion controller 112 is coupled to or deployed on CPI 210.

The location of the receiver-side congestion controller 112 on the CPI 210 is advantageous because the CPI 210 has a unique vantage point in that it forwards the exact same traffic as just before the bottleneck 108 (“the last mile bottleneck”). Thus, L4S compatible controllers can be deployed in L4S low-latency queue because CPI 210 causes the sender-side congestion controller 104 to behave in a scalable manner for all bottlenecked queue-building (QB) flows.

Leveraging L4S with non-compliant receivers is problematic because the L4S congestion signals are explicit, as opposed to Adaptive Congestion Control (ACC), which is a receiver-side congestion controller that infers congestion implicitly rather than explicitly. However, the problem is twofold:
(1) L4S bottlenecks only mark congestion events, if the ECT (1) has been set by the sender 102; when congestion is detected the L4S bottleneck sets the field Congestion Experienced (CE) (indicating that congestion was experienced).
(2) TCP ECN echo will only be ‘accurate ECN’ for L4S TCP receivers. In other words, to receive useful congestion information from the L4S, the client 218 must support L4S ‘accurate ECN’. Specifically, from a typical L4S perspective, when downloading, the server 201 sets the IP ECN field to ECT (1), and in the presence of congestion, the bottleneck 108 sets the IP ECN field to Congestion Experienced (CE). When uploading, the receiver 114 echoes back congestion using accurate ECN.

Similarly, CPI 210 detects NQB traffic, such as games, and marks the non-queue-building traffic DSCP 45 so the packets are enqueued in the low-latency queue. However, this only applies in the upload direction, as the CPI 210 is after the download bottleneck.

The CPI 210 communicates with a node having marking logic 106 before or on the bottleneck 108 to mark packets in a certain manner. Specifically, marking logic 106 (e.g., at the headend) could:
(1) mark all download TCP packets with ECT (1) (so that L4S marking is applied),
(2) reflect the upload DSCP 45 field for non-queue-building (NQB) flows, and
(3) mark ECT (1) for queue building (QB) flows with sender-side congestion controllers (so that L4S marking is applied).

By marking all download TCP packet, QB flows with sender-side congestion controllers with ECT (1) and reflecting upload packets as DSCP 45, the results are optimal.

Note that if the server 201 and bottleneck 108 support L4S, and the client 218 does not support L4S. The CPI 210 can make the LAN client compliant with the scalable congestion protocol by either (1) implementing the receiver-side accurate ECN in the upload direction or (2) controlling the sender congestion response using the TCP ack window in the upload direction.

Note, ACC itself does not require any L4S information to function. Congestion can be reduced by modifying ACC by coupling:
receiver side congestion control (timing the acks and overwriting the windows) and
deploying ACC on CPI 210.

Deploying the ACC on the CPI 210 improves the ability to obtain accurate congestion information (and compensate accordingly to reduce congestion) because the CPI 210 has a unique vantage point in that it forwards the same (e.g., the exact same) traffic as the “last-mile bottleneck.” Thus, receivers that cannot interoperate with L4S can now be deployed since the CPI 210 applies the scalable congestion control (e.g., sender-side congestion controller 104) to all bottlenecked flows.

In L4S, the congestion signals (L4S ECN) are explicit, which facilitates employing L4S (by contrast, the congestion level of ACC must be inferred). However, the difficulty in deploying L4S is threefold:
L4S bottlenecks only mark congestion events via IP CE if the ECT (1) has been set by the sender 102 and
the L4S receiver must support “accurate ECN” so that it can echo back the congestion extent to the sender.

The L4S server must 1) mark outgoing packets with ECT(1), and 2) respond to accurate ECN information in a scalable congestion controller manner.

In other words, to receive useful congestion information from L4S, the L4S server must receive ACC ECN. The L4S server must receive an indication that the receiver supports L4S. Specifically, when downloading, the server 201 must set ECT (1), and when uploading, the client 218 must support accurate ECN. Since the upstream bottleneck is on the HG, by locating the receiver-side congestion controller 112 at the HG, it is relatively easy to update the receiver-side congestion controller 112 and/or the HG to include QoS to optimize QoE for the home users. However, in the downstream direction, the same approach would require upgrading some device between BNG 204 and DSLAM (equivalent). Fortunately, the upload problem is far less of a problem because the bottleneck 108 in the upload direction is typically on the CPI 210. Additionally, DRR-based queuing or AQMs solve the bottleneck problem. Consequently, this specification focuses primarily on the downstream congestion (but the same principles and structure can be applied). Aggregate devices have limited resources, and aggregate devices cannot deploy sophisticated QoS mechanisms, e.g., deficit-round-robin (which may include a queue for each flow).

Similarly, the CPI 210 can detect NQB traffic, such as games, and mark the NQB traffic for expedited forwarding (DSCP 45) to enqueue packets in the low-latency queue. However, again, this will only apply in the upload direction, as the CPI 210 is after the download bottleneck (and so, this is not a complete solution).

In some embodiments, CPI 210 communicates to a node having marking logic 106 before or on the bottleneck 108 to mark packets in a certain manner. Specifically, the node having marking logic 106 (e.g., at the headend) could:
mark all download TCP packets or all packets with ECT (1) (e.g., via marking logic 106) so that L4S congestion markings are applied by the bottleneck 108, and
mark DSCP 45 for downstream flows that have a corresponding upload flows marked with DSCP 45 field (i.e., in packets sent to sender 102) i.e., reflect the DSCP 45 marking in the downstream.

With this approach, in some embodiments, the results would be optimal.

Note that if the server 201 and bottleneck 108 support L4S and the client does not, the CPI 210 can make the LAN client appear compliant either:
1) By implementing the receiver-side accurate ECN in the upload direction.
2) By remotely controlling the server congestion response by overwriting the TCP ack window in the upload direction.

In Summary:

Mark all traffic, or at least a subset of the traffic, ECT(1) (an ECT(1) packet is classified as ‘ECN-capable’, which an L4S bottleneck will recognize as L4S compatible. If congestion increases, an L4S AQM algorithm will increasingly mark the IP-ECN field as CE), reflecting the upload DSCP 45 field for flows (DSCP 45 specifically corresponds to a code point that indicates expedited forwarding (EF). It can be useful to mark messages for EF for time-sensitive traffic, where low latency and low loss are critical for maintaining quality. It can be useful to mark messages for EF in networks where quality of service is a priority).

Note that if the bottleneck 108 does not support L4S markings, the receiver-side congestion controller 112 can still operate with any bottleneck 108 that marks packets (e.g., with CE) based on a threshold on the size of the queue. For example, a policer (logic that polices traffic) that may use CE markings to regulate the traffic instead of dropping packets. In this case, there is no need to mark traffic with ECT(1), as that is only required to enable marking on an L4S-compliant bottleneck.

For non-queue-building protocols, receiver-side congestion controller 112 identifies non-queue-building protocols using DPI or behavioral flow analysis. Once identified, the receiver-side congestion controller 112 marks the traffic with DSCP 45 so that the messages of the traffic are placed in the low-latency queue.

For QB TCP traffic, receiver-side congestion controller 112 when detecting the congestion markings from the L4S bottleneck, updates the TCP receive window in the acknowledgement (using a scalable congestion control algorithm) to limit the sender's window (and rate) and maintain a low-latency queue.

### QUEUE BUILDING UDP (OR NON-TCP) TRAFFIC

The problem with UDP traffic:

Typically, UDP messages do not have a receive window to overwrite, and even if UDP traffic did have receive windows, UDP traffic is often fully encrypted (e.g., Quick UDP Internet Connections (QUIC) protocol). Consequently, overwriting the receive window is at best challenging.

Typically, UDP traffic has a non-scalable congestion controller. Thus, a congestion event (either packet-loss or ECN) results in a drastic reduction or at least an over-compensation in the sender rate, which, in turn, results in an underutilized link.

The receiver-side congestion controller 112 causes the sender-side congestion controller 104 to modify the sending rate and/or window based, and in some embodiments, on the equation,

$$Rate = window / RTT . \qquad ( Eq . 4 )$$

Thus, the rate can be reduced by increasing the Round-Trip-Time (RTT).

The RTT can be increased by having the receiver-side congestion controller 112 steal acknowledgement packets and delay reinjection of the packets, decreasing the sending rate. Also, since time is continuously controlled, the rate can be controlled with high fidelity in a scalable manner. By contrast, controlling the sending rate by dropping messages results in the sender-sider congestion controller 104 making a much coarser rate adjustments.

Also, queue-building traffic is rarely latency-sensitive, so increasing RTT is not an issue, because the throughput will still be high. Increasing the RTT will only delay the acknowledgments and not the travel time of the data between the sender and receiver. Consequently, latency for data is still low, despite delaying acknowledgments.

Stealing packets instead of acknowledgments requires stealing more data and using more memory (packets tend to contain more data than acknowledgments). So, in some embodiments, the receiver-side congestion controller 112 will occasionally drop (or ECN mark) packets, so that the window is reduced significantly, and then continue to control the flow using delays.

Thus, by comparing the window growth rate with the Eq. 2 or Eq. 4, for example, the receiver-side congestion controller 112 can decide when to drop packets and how much to delay packets to control the rate based on the congestion marking from L4S.

In some embodiments, the window growth is assumed to be parameterized by B in equation 2. In some embodiments, the receiver-side congestion controller 112 probes (e.g., by measuring rate and dropping packets) to determine the window growth rate. Alternatively, receiver-side congestion controller 112 determines the type of controller that sends the messages based on the content and/or format of the message/message header. In some embodiments, receiver-side congestion controller 112 stores a table correlating growth rates of different protocols that correlates the growth rate with the protocol.

### FURTHER DISCUSSION

The receiver-side congestion controller 112 does not have to be deployed on the end-user's CPE. The receiver-side congestion controller 112 can be placed on any middlebox 110 after the L4S bottleneck.

### L4S NON-QUEUE-BUILDING-PROTOCOL PACKET JOURNEY

If the sender-sider congestion controller 104 (the protocol) does not probe for bandwidth and has insufficient bandwidth demands to induce a queue, then sender-sider congestion controller 104 can request its packets to be enqueued in the low-latency queue. The queue is oblivious of the L4S packet marking, but it does not matter since the lack of a marking is not the reason for the queue. To indicate that a flow is NQB, and thus request that the flow be enqueued in the low-latency queue, the DSCP field must be set to DSCP 45.

The receiver-side congestion controller 112, at the CPI 210 (e.g., on the HG/CPE), can identify which application is creating the packets/flows using:

Deep Packet Inspection (DPI) and/or Behavioral Identification (BI). DPI inspects the payload(s) of packets from a flow to identify the traffic. BI monitors the behavior of a flow to identify the type of flow. In the upstream direction, the CPI 210 (CPE/HG) is before the bottleneck 108. Therefore, the receiver-side congestion controller 112 can cause the CPI 210 (e.g., CPE), or another node on which marking logic 106 is installed, to directly mark DSCP 45 for the identified NQB traffic. However, this is not the case in the downstream direction. Therefore, a device at the BNG 204 or before or at the downstream bottleneck (call the device X) reflects the DSCP 45 that was set in the upstream direction, thereby copying the behavior of the CPI 210. From X's perspective, it is not possible to know if DSCP 45 was set by a home L4S-compatible client or the CPI 210 in the upstream direction. In the former case, it would be wrong to assume that the downstream should be marked in the same way. So, another marking scheme to indicate X to reflect DSCP 45 in the downstream direction may be used.

### ALGORITHM

### Download Traffic

FIG. 3 is an embodiment of a method 300 that the system of FIG. 1 implements on messages traveling from sender 102 to receiver 114. As shown in FIG. 3, in step 301, receiver-side congestion controller 112 inspects messages to determine the nature of the traffic being sent by sender 102, whether sender-side congestion controller 104 is present, and/or the nature of the sender-side congestion controller 104. For example, in some embodiments, traffic is categorized using BI or DPI, based on the content of the message headers, the content of the message payload and/or the behavior of the flow. For example, L4S uses the last codepoint of the Internet Protocol header's ECN field that had not previously been assigned to signal that traffic is from an L4S-capable sender. The code 00 indicates non-ECN communication, 01 indicates L4S ECN, 10 indicates classic ECN, and 11 indicates marked as congested. Then, the nature of the sender-side congestion controller 104 is inferred from the nature of the traffic.

In step 302, receiver-side congestion controller 112 determines whether the traffic is TCP traffic. If the flow is a TCP flow, in some embodiments, receiver-side congestion controller 112 determines whether sender-side congestion controller 104 of sender 102 is scalable (e.g., whether sender-side congestion controller 104 is an L4S controller).

If the flow is a TCP flow, the method 300 continues with step 304, in which the TCP receive window of the acknowledgment is overwritten by the receiver-side congestion controller 112 with messages according to the protocol used by the sender-side congestion controller 104 (e.g., a protocol of a scalable congestion controller (e.g., L4S)).

If the flow is not a TCP flow, the method 300 continues to step 308, in which the receiver-side congestion controller 112 determines whether the messages are part of a QB flow.

In step 308, if the flow is NQB, the method 300 continues to step 310, where the upstream messages are marked by the receiver-side congestion controller 112 (by code executed on the middlebox or a firewall in the middlebox 110) DSCP 45 (for expedited forwarding). Additionally, the receiver-side congestion controller 112 may also send a message to the marking logic 106 requesting that the marking logic 106 mark messages of the flow for expedited forwarding (in the download direction).

Returning to step 308, if the message is QB, the method continues to step 312, in which receiver-side congestion controller 112 determines whether the flow is being managed by a sender-side congestion controller 104.

In step 314, if there is no such sender-side congestion controller 104, no action is taken.

Returning to step 312, if receiver-side congestion controller 112 determines that a sender-side congestion controller 104 manages the flow, the method continues to step 316. In step 316, the receiver-side congestion controller 112 controls the sender window by using a combination of actions, including delaying acknowledgements and dropping packets (or ECN). Steps 302, 308, and 312 have the effect of categorizing traffic. In some embodiments, the categorizing of traffic is performed by step 301 without expressly performing the decisions of steps 302, 308, and 312, and/or the decisions of steps 302, 308, and 312 are made as part of step 301.

Step 316 includes step 318. In step 318, the flow rate is adjusted by receiver-side congestion controller 112, by adjusting the RTT, (e.g., based on rate =window/RTT). Specifically, increasing RTT decreases the rate. Similarly, decreasing the RTT increases the rate. Step 318 includes steps 320, 322, and 324.

In step 320, acknowledgement packets are “stolen” (that is, the acknowledgement messages are captured and inspected) by receiver-side congestion controller 112.

In step 322, the acknowledgement messages are reinjected into the flow at the designated times determined by the receiver-side congestion controller 112 to reduce the flow rate. The longer the delay between stealing a message and reinjecting the message, the longer the RTT and the slower the rate. In some embodiments, as part of step 322, receiver-side congestion controller 112 sends messages to the sender 102, which has the effect of controlling the window used by the sender 102. Specifically, causing receiver-side congestion controller 112 to send a message to sender 102 with congestion information encoded (e.g., if the sender-side congestion controller 104 is compliant with ‘accurate ECN’). According to Eq. 6, increasing the window increases the sending rate, and decreasing the window decreases the sending rate.

After step 322, in step 324, receiver-side congestion controller 112 determines whether it is time and/or otherwise appropriate to drop an acknowledgment. For example, receiver-side congestion controller 112 determines whether the number of acknowledgments being stored (that are waiting to be reinjected) is above a threshold number, or whether the queue at the bottleneck 108 is above a certain threshold. If the threshold is exceeded or if it is appropriate to drop a message for other reasons, a message is dropped by the receiver-side congestion controller 112. After the message is dropped or if a determination is made not to drop a message, the method 300 returns to stealing the next acknowledgment.

If, in step 324, receiver-side congestion controller 112 determines that it is time to drop the acknowledgement message, the method 300 continues to step 326, in which packets are dropped by receiver-side congestion controller 112. After step 326, method 300 returns to step 320.

Returning to step 324, if receiver-side congestion controller 112 determines that it is not time to drop a packet, the method 300 returns to step 320 (without dropping any packets).

### OPERATION OF MARKING LOGIC

Method 400 of FIG. 4 is implemented by marking logic 106 on messages traveling from sender 102 to receiver 114. In step 402, the marking logic 106 determines whether the flow uses TCP. If the flow uses TCP, the method 400 continues to step 404, where the flow is marked by the marking logic 106 ECT(1). Returning to step 402, if the flow does not use TCP, the method 400 continues to step 406, where a determination is made by marking logic 106 whether packets in the flow's reverse direction are marked for expedited forwarding (and optionally whether another field is marked to indicate that the middlebox 110 performed the marking). If in step 406, it is determined that the packets in the flow's reverse direction are marked for expedited forwarding, then the method 400 continues to step 408. In step 408, the messages are marked by marking logic 106 for expedited forwarding (e.g., DSCP 45), indicating that messages should be enqueued in the low-latency queue (e.g., enqueued in the L4S low-latency queue). If the flow is not marked for expedited forwarding (e.g., DSCP 45), then the method 400 continues to step 410. In step 410, a determination is made by marking logic 106 whether the flow is controllable. For example, the flow may be a UDP QB controllable flow. If the flow is controllable, the method 400 continues to step 412, where marking logic 106 marks the flow ECT (1) to indicate expedited forwarding. Returning to step 410, if in step 412, the flow is not controllable, the method 400 continues to step 414, and no action is taken.

### SETTING UP THE RECEIVER-SIDE CONGESTION CONTROLLER AND MARKING LOGIC

FIG. 5 illustrates a flowchart of an embodiment of method 500 of setting up the system of FIG. 1. In step 502, the receiver-side congestion controller 112 is installed at the customer premises. In step 504, the receiver-side congestion controller determines the location of the bottleneck 108. In some embodiments, NDI 208 is assumed to be the location of a bottleneck 108, because NDI 208 handles (e.g., manages and/or controls) a higher bandwidth than CPI 210 is capable of handling. In step 506, the network operator determines the device/location at the bottleneck 108 or of a device between the bottleneck 108 and the sender 102 for installing the marking logic 106. The location for the marking logic 106 could be found by reading a routing table, such as a routing table on a device at the bottleneck 108. In step 508, the marking logic 106 is installed by a network operator at the node found in step 506. Marking logic may be installed at the node by programming the device using its QoS CLI (e.g., Cisco IOS CLI), Access Control Lists (ACL), or programming using a domain-specific language like P4. If the marking node is Software Defined Networking (SDN) capable, then it may be installed via the SDN protocol (e.g., OpenFlow). Alternatively, if the marking node is running a general-purpose OS such as Linux it can be installed via the QoS subsystems (e.g., TC, conntrack, and IPtables). For marking ECT(1) based on all or a subset of traffic, a permanent static rule can be installed using the aforementioned installation methods. To reflect DSCP 45, the marking node must be stateful so that it can insert a temporary rule to mark DSCP 45 for the flow-tuple that is the reflection of the incoming DSCP 45 flow.

### OPERATION OF MARKING LOGIC

FIG. 6 illustrates a flowchart of an embodiment of method 600 implemented by the marking logic 106. In step 602, a message is received and/or intercepted at the marking logic 106 from the receiver-side congestion controller 112. In step 604, the marking logic 106 parses the message. In some embodiments, the message includes information, via which the flow can be identified, such as information (e.g., the 5-tuple) identifying the sender and receiver (to determine whether to mark a message). In step 606, a message from the sender 102 and/or to receiver 114 is intercepted. In step 608, the marking logic 106 determines which flow the message belongs to. In some embodiments, the header information identifying the sender 102 and the receiver 114 is used to identify the flow. Optionally, marking logic 106 installs a temporary rule on bottleneck 108, NDI 208, AGG 206, or BNG 204 to mark DSCP 45 in the reverse direction (the downstream direction).

In step 610, marking logic 106 compares the information sent in the message from the receiver-side congestion controller 112 to the information read from the message identifying the flow. For example, in step 610, a determination is made whether there is a match between the identifier(s) associated with the flow (as indicated in the message from the receiver-side congestion controller 112) and the identifiers associated with the message intercepted. If there is a match between the information from the receiver-side congestion controller 112 and the information in the message intercepted, then the method 600 proceeds to step 612. In step 612, the message intercepted is marked for expedited forwarding. After step 612, method 600 continues to step 614, where the messages intercepted are returned to the forwarding path. After step 614, the method 600 returns to step 604 to intercept the next message. Returning to step 610, if there is no match, the method 600 continues directly to step 614, without performing step 612. If a period of nonactivity lasts for more than a threshold amount of time, the rule is uninstalled.

### RECEIVER-SIDE CONGESTION CONTROLLER (LOGIC)

FIG. 7 illustrates a block diagram of an embodiment of the receiver-side congestion controller 112. In some embodiments, receiver-side congestion controller 112 includes timer 702, Input/Output (I/O) 704 having receive messages 706 and send messages 708, traffic categorization 710, window size controller 712, rate control 714, congestion message generator 716, message marker 718, marking logic 720, and marking logic installer 722. In some embodiments, timer 702 determines how long to wait between stealing an acknowledgment and reinjecting the acknowledgment. In some embodiments, timer 702 includes logic for reading the clock of the middlebox 110. I/O 704 controls the input and output of the receiver-side congestion controller 112. I/O 704 may include buffers for temporarily storing incoming and outgoing messages. Receive message 706 may include logic for reading incoming messages. In some embodiments, receive message 706 includes logic that reads the header information of incoming messages needed for implementing method 300. Send message 708 may include logic that causes the receiver-side congestion controller 112 to send messages to the marking logic 106 and to reinject stolen acknowledgments and messages. In some embodiments, traffic categorization 710 includes logic for categorizing messages. In some embodiments, traffic categorization 710 includes logic for implementing steps 302, 308, and 312. Window Size Controller 712 computes actions to take for controlling the size of the congestion control window, within which messages can be exchanged prior to the sender changing the window size. For example, the window size controller 712 may include logic for computing when to send the next acknowledgment to keep the window from closing. Rate controller 714 includes logic for controlling the rate at which acknowledgments are sent from the receiver-side congestion controller 112 to the sender 102. In some embodiments, rate controller 714 determines when to cause send message 708 to send an acknowledgment based on timer 702 and/or window size controller 712. In some embodiments, window size controller 712 includes logic for performing the actions of step 316, and rate controller 714 includes logic for performing step 318. Congestion message generator 716 includes logic for generating messages related to conveying the presence of and the degree of congestion. Message marker 718 attaches the messages generated by congestion message generator 716 to messages. Message marker 718 performs steps 304 and 310 of method 300, as needed. Marking logic 720 is a copy of the marking logic 106 that is stored on receiver-side congestion controller 112 for installation at an appropriate location. Marking logic installer 722 includes logic for installing marking logic 720 (at the appropriate location).

### MARKING LOGIC

FIG. 8 illustrates a block diagram of a marking logic 800, which in some embodiments, includes I/O 802. In some embodiments, I/O 802 includes receive information 804 and send message 806. In some embodiments, marking logic 800 includes read message 808, read header 810, mark message 812, and comparator 816. In some embodiments, classifier 807 includes read message 808, read header 810, and parser 814.

In some embodiments, marking logic 106 includes at least two parts: (1) a classifier and (2) a marker. The classifier determines which packets are marked, and the marker updates the marks (for those packets that are marked). For marking all traffic (or a subset of traffic, e.g., TCP traffic) with ECT(1), a simple non-stateful classifier is sufficient. However, responding to markings from the receiver-side congestion controller 112 requires a stateful classifier that can mark packets based on the reverse directions 5-tuple. The 5-tuple includes (1) the source IP address, (2) the destination IP address, (3) the source port, (4) the destination port, and (5) an indication of the protocol used. The source IP address is the IP address of the device sending the message. The destination IP address is the IP address of the device intended to receive the communication. The source port is the port number used by the source device to establish communication. Typically, this is a dynamically assigned ephemeral port. The destination port is the port number on the destination device where the service or application is running. The protocol is an indication of the transport protocol used for the communication (e.g., TCP, UDP, ICMP).

The marking logic 106 inspects these attributes to identify and mark flows. The marking logic 106 tracks flows using the 5-tuple to associate packets with specific sessions. The 5-tuple is used to classify and prioritize traffic based on the QoS. The combination of the 5-tuple values uniquely identifies a network session or flow. The uniqueness of the 5-tuple helps ensure the correct routing and handling of packets in environments with multiple concurrent sessions. The marking and classifying can be achieved by programming BNG 204 and NDI 208 using a QoS CLI (e.g., Cisco IOS CLI) or via an Access Control List (ACL). The programming may be performed using a domain-specific language like P4. If the BNG 204 or NDI 208 is a software-defined networking (SDN) capable device, BNG 204 or NDI 208 can be programmed using the SDN communication protocol (e.g., OpenFlow). If the BNG 204 or NDI 208 runs a general-purpose OS such as Linux, the BNG 204 or NDI 208 can use the QoS subsystem, such as Transport Communications (TC), conntrack (connection tracker), or IPtables. The BNG 204 or NDI 208 can be programmed using a less common language, or programmed using a general-purpose language or interpreted language (e.g., C to eBPF).

Receive information 804 includes logic for performing step 602. Send message 806 includes logic that places messages back into the flow. Send message 806 includes logic for performing step 614. Classifier 807 classifies messages. Read message 808 includes logic that reads the body of a message. Read message 808 performs step 602. Read header 810 includes logic that reads the header information of messages, which is used in step 608. Mark message 812 includes logic that marks the messages for expedited handling. Mark message 812 includes logic that performs step 612. Parser 814 includes logic that parses the content of messages and header information. Parser 814 and classifier 807 perform steps 604 and 608. In some embodiments, read message 808, read header 810, and parser 814 are all the same module. Comparator 816 includes logic that compares information in the header of an intercepted message to the information sent by the receiver-side congestion controller 112. Comparator 816 performs step 610 to determine whether to mark a message.

### SENDER-SIDE CONGESTION CONTROLLER (Logic)

FIG. 9 illustrates a block diagram of an example of a sender-side congestion controller 104, including a protocol logic 900. In some embodiments, protocol logic 900 includes congestion reaction 902, having a start phase 904 and a congestion avoidance phase 906. Protocol logic 900 also includes congestion detection 908, having message drop detection 910, and queue monitoring 912. Congestion detection 908 also optionally includes congestion messaging logic 914, having a degree of congestion notification 916. The protocol logic 900 includes logic that implements messaging protocols such as TCP and/or L4S. Protocol logic 900 includes logic that triggers congestion reaction 902, which reacts to congestion to alleviate the congestion. In some embodiments, congestion reaction 902 includes logic that adjusts a window size based on whether or not there is congestion. In some embodiments, congestion reaction 902 includes a start phase 904, which quickly increases the window size during a startup phase until the window size reaches an optimum value (based on information available to sender-side congestion controller 104), which is some embodiments is the bottleneck-bandwidth*round-trip-time. Start phase 904 is a window growth phase in which the window of maximum in-flight packets is increased from a relatively small initial value to a more ideal number (the ideal is the bandwidth-delay product), until a message is dropped, or until another indication is detected or received that the window is too large. In some embodiments, congestion reaction 902 also includes congestion avoidance phase 906 for avoiding congestion. In some embodiments, the congestion avoidance phase 906 uses a TCP congestion control protocol and/or L4S protocol to avoid congestion. In some embodiments, protocol logic 900 includes congestion detection 908, which detects congestion. In some embodiments, congestion detection 908 includes message drop detection 910, queue monitoring 912, congestion messaging logic 914, and degree of congestion notification 916. Message drop detection 910 detects whether a message has been dropped. Queue monitoring 912 monitors the number of messages in a queue and whether the queue is full. Congestion messaging logic 914 creates messages indicating whether or not there is congestion. Degree of congestion notification 916 parses and/or sends messages indicating a degree of congestion.

### HARDWARE

FIG. 10 illustrates an example of a router 1000 that can be used in the system of FIG. 1. In some embodiments, router 1000 includes Central Processor Unit (CPU) system 1002, Ethernet/Mac 1004, packet switch 1006, WLAN 1008, main memory 1010, and secondary flash memory 1012. For example, the CPI 210 could be a router according to FIG. 10. Similarly, the NDI 208 may include a router according to FIG. 10. Also, the middlebox 110 may be located on a router according to FIG. 10. In some embodiments, router 1000 includes CPU system 1002, ethernet/MAC 1004, packet switch 1006, WLAN 1008, main memory 1010, and secondary flash memory 1012. Ethernet/MAC 1004 includes an Ethernet interface and MAC addresses. Packet switch 1006 receives packets and determines where and when to send the packets. In some embodiments, packet switch 1006 inspects the packet to determine where to send packets and whether the packet is marked for expedited forwarding. WLAN 1008 includes routes and network-enabled machines on the customer premises, such as home network 220. Main memory 1010 includes machine instructions, which can be invoked by the processor for implementing the algorithms, methods, controllers, and systems of FIGS. 3-9 and machine instructions related to interacting with a UE 222 or server 201 based on TCP and L4S protocols. Bus 1014 facilitates exchanging messages between CPU system 1002, Ethernet/MAC 1004, packet switch 1006, WLAN 1008, main memory 1010, and secondary flash memory 1012. In some embodiments, CPU system 1002 and/or router 1000 include logic that implements the algorithms, methods, controllers, and systems of FIGS. 3-9.

FIG. 11 illustrates an example of a network machine 1100 that may be used as the sender, receiver, or other device of FIG. 1 or 2. In some embodiments, network machine 1100 includes memory system 1102, network interfaces 1104, processor system 1106, and Input/Output 1108. Main memory system 1102 stores machine instructions for implementing or communicating based on TCP and/or L4S protocols. In some embodiments, main memory system 1102 stores machine instructions for implementing the algorithms associated with marking logic 106 and middlebox 110. Main memory system 1102 includes machine instructions (or logic) for implementing the algorithms, methods, controllers, and systems of FIGS. 3-9 and machine instructions related to interacting with a UE 222 or server 201 based on TCP and L4S protocols. Network interface 1104 interfaces with a network, receiving packets from the network and sending messages to the network. Processor system 1106 implements the machine instructions stored in main memory system 1102. In some embodiments, processor system 1106 and/or network machine includes logic that implements the algorithms, methods, controllers, and systems of FIGS. 3-9. Input/Output 1108 includes user interfaces (e.g., keyboards, touchscreens, mice, touchpads, etc.) and output devices (e.g., monitors, printers, etc.). In some embodiments, network machine 1100 performs the same functions as router 1000, but has a different architecture, with no bus.

### ALTERNATIVES AND EXTENSIONS

Each embodiment disclosed herein may be used or otherwise combined with any of the other embodiments disclosed. Any element of any embodiment may be used in any embodiment.

Although the invention has been described regarding specific embodiments, it will be understood by those skilled in the art that various changes may be made, and equivalents may be substituted for elements thereof without departing from the true spirit and scope of the invention. In addition, modifications may be made without departing from the essential teachings of the invention.

1. A system comprising:
a processor system including one or more processors; and
a memory system storing machine instructions, which, when invoked, cause the processor to implement a method including at least:
determining that a sender includes a protocol that controls congestion;
and
a receiver-side congestion controller overwriting information of the acknowledgment, with information that is compliant with the protocol, therein, remotely affecting a sending rate of a sender-side congestion controller and enabling the receiver-side controller to affect a behavior of the sender-side controller.

2. The system of claim 1, the memory system including machine instructions, wherein invoking the machine instructions causes the processor system to mark messages being sent from the receiver to the sender, indicating that a flow should be treated with expedited forwarding.

3. The system of claim 2, the memory system further storing machine instructions, which, when invoked, cause the processor system to further mark the messages that are marked to indicate that a receiver-side congestion controller marked the messages for expedited forwarding.

4. The system of claim 1, the memory system further storing machine instructions, wherein invoking the machine instructions causes:
the receiver-side congestion controller sends a message to marking logic, the message identifying a flow from the sender to the receiver, whose messages are to be marked for expedited forwarding;
wherein a bottleneck is located between the marking logic and the receiver-side congestion controller.

5. The system of claim 1, the processor system being located at a Customer Premises Interface (CPI).

6. The system of claim 5, the CPI being a Customer Premises Equipment.

7. The system of claim 1, the sender being a server and the receiver being a client of the sender.

8. A system comprising:
a processor system including one or more processors; and
a memory system storing machine instructions, which, when invoked, cause the processor to implement a method including at least:
determining that a sender includes a scalable protocol that controls congestion;
a receiver-side congestion controller interpreting a message sent from the sender to the receiver, the message indicating that congestion was experienced; and
the receiver-side congestion controller updates an acknowledgment from the receiver to the sender to include information indicating an extent of congestion, therein, causing the sender-side controller to treat the receiver as compliant with the scalable protocol.

9. The system of claim 8, the scalable protocol being a Low Latency, Low Loss, and Scalable Throughput (L4S) protocol.

10. The system of claim 9, where the indication of the degree of the congestion indicates which messages were received with a congestion marking or which messages were received without the congestion marking.

11. A system comprising:
a processor system including one or more processors; and
a memory system storing machine instructions, which, when invoked, cause the processor to implement a method including at least:
a receiver-side congestion controller implicitly determining whether congestion was experienced based on traffic parameters; and
the receiver-side congestion controller affecting acknowledgements sent to the sender on behalf of the receiver to affect a rate at which messages are sent by the sender.

12. The system of claim 11, the memory system further storing machine instructions, which, when invoked by the processor system, cause the processor system to inspect messages to determine whether traffic sent by the sender is TCP or non-TCP.

13. The system of claim 12, the memory system further storing machine instructions, which, when invoked by the processor system, causes the processor system to, if the traffic is non-TCP, determine whether the traffic is queue building (QB) or non-QB.

14. The system of claim 13, the memory system further storing machine instructions, which when invoked by the processor system, cause the processor system to, when the traffic is non-TCP and non-QB, (1) mark messages of a flow as enabled for the scalable protocol and (2) mark messages flowing upstream for expedited forwarding.

15. The system of claim 14, the memory system further storing machine instructions, which, when invoked by the processor system, causes the processor system to, when the traffic is non-TCP and QB, but the sender has no congestion controller, take no action.

16. The system of claim 14, the memory system further storing machine instructions, which when invoked by the processor system, causes the processor system to, when the traffic is non-TCP and QB, but the sender has a sender-side congestion controller, control a window set by the sender-side congestion controller by at least controlling a timing of when acknowledgments are sent.

17. The system of claim 14, the memory system further storing machine instructions, which, when invoked by the processor system, causes the processor system to capture an acknowledgment and reinject the acknowledgment after a specified time to set a round-trip time (RTT), to cause a window to be set to a desired value.

18. The system of claim 11, the memory system further storing machine instructions, which, when invoked by the processor system, causes the processor system to determine whether to drop a message to cause the sender-side congestion controller to adjust the window, based on the protocol of the sender-side congestion controller.

19. The system of claim 11, the memory system further storing machine instructions, which when invoked by the processor system, causes the processor system to, capture an acknowledgment and reinject the acknowledgment after a specified time to set a round-trip time (RTT), to cause the sender-side congestion controller to set a window to a desired size, based on the protocol of the sender-side congestion controller.
